(19) United States
(12) Patent Application Publication
(10) Pub. No.: US 2010/0064864 A1
(43) Pub. Date: Mar. 18, 2010

(54) Double Hammer Clutch Impact Wrench

(75) Inventor: Shigeki Kobayashi, Nagano (JP)

Correspondence Address: SENNIGER POWERS LLP, 100 NORTH BROADWAY, 17TH FLOOR, ST LOUIS, MO, 63102, US

(73) Assignee: SP AIR KABUSHIKI KAISHA, Nagano (JP)

(21) Appl. No.: 12/559,942

(22) Filed: Sep. 15, 2009

Related U.S. Application Data
(60) Provisional application No. 61/096,955, filed on Sep. 15, 2008.

(51) Int. Cl. B25B 19/00; B25B 13/46; B25B 21/00

(52) U.S. Cl. 81/464; 81/60; 81/57.44

(57) ABSTRACT

A power driven tool for rotating a mechanical fastener including a housing with a motor positioned in the housing. The motor includes a drive shaft that rotates relative to the housing. An impact mechanism in the housing is operatively connected to the motor drive shaft. The impact mechanism has a base, an output and a cam. The output and cam are rotatably mounted on the base. A pair of hammers are pivotally mounted on the base and selectively positioned by the cam. The cam biases the hammers to intermittently impact the output. A ratchet head assembly is operatively connected to the output of the impact mechanism. The ratchet head assembly includes an output member rotatably mounted on the housing to rotate the mechanical fastener. The assembly also includes a ratchet operable to limit rotation of the output member in a selected direction.

### CROSS-REFERENCE TO RELATED APPLICATIONS

This application claims benefit of U.S. Provisional Patent Application No. 61/096,955, filed Sep. 15, 2008, and entitled, “Double Hammer Clutch Impact Wrench”, which is hereby incorporated by reference in its entirety.

### BACKGROUND OF THE INVENTION

This invention relates generally to power driven tools, and more specifically it relates to a power driven tool for tightening or loosening fasteners having an impact drive with a double hammer clutch.

Power driven tools for tightening or loosening fasteners (e.g., nuts and bolts) are known, and power driven tools incorporating impact drives that can intermittently provide an increased amount of torque for tightening or loosening fasteners are common.

An impact wrench incorporating a ratchet head is disclosed in co-owned U.S. Pat. No. 4,821,611 (Izumisawa). A pneumatic motor rotates a clutch case that coaxially houses an impact drive. Under normal operation, a cam ball fixed within the clutch case engages a finger of an impact clutch and rotates the clutch conjointly with an output shaft for tightening or loosening the fastener. But when frictional resistance of the fastener exceeds the normal torque output of the tool, the cam ball slides under the impact clutch finger and pushes the clutch axially forward along the output shaft. This conjointly moves a pair of hammers forward into registration with a corresponding pair of anvils of the output shaft. The hammers instantaneously impact the anvils and produce an increased amount of torque in the output shaft for overcoming the frictional resistance of the fastener. Immediately following the impact, the hammers retreat axially rearward and when the cam ball makes one full rotation with the clutch case, the impact process repeats.

However, the clutch case and cam ball generally move at a rate equal to the output speed of the motor, which is very high for pneumatic motors. Therefore when the output shaft is unable to turn the fastener, the cam ball repeatedly pushes the impact clutch and hammers axially forward at a similar rate. This often occurs so rapidly that the hammers impact the anvils before corresponding surfaces fully register, or alternatively the hammers completely miss the anvils and fail to produce any additional torque. Moreover, when the frictional resistance of the fastener exceeds the additional torque produced by the hammers, the cam ball and impact clutch may unnecessarily push the hammers into repeated registration with the anvils before an operator can disengage the motor. This can be hard on components of the impact drive (e.g., the cam ball and impact clutch) and may damage them or prematurely wear them out before other components of the wrench.

Co-owned U.S. Pat. No. 7,080,578 (Izumisawa) incorporates a speed reducing mechanism in the power driven impact wrench. This particular design reduces the speed of the motor output and controls the impact rate of the hammers of the impact drive. While the components of the impact drive are less prone to damage and wear, the speed reducing mechanism requires the use of additional components which add complexity to the tool.

Therefore, it would be desirable to design a power driven ratchet tool having an impact drive capable of providing adequate damage and wear protection without the use of a speed reducing mechanism.

### SUMMARY OF THE INVENTION

This invention relates generally to a power driven tool for rotating a mechanical element. The tool generally comprises a housing with a motor positioned in the housing. The motor includes a drive shaft that rotates relative to the housing. An impact mechanism in the housing is operatively connected to the motor drive shaft. The impact mechanism has a base, an output and a cam. The output and cam are rotatably mounted on the base. A pair of hammers are pivotally mounted on the base and selectively positioned by the cam. The cam biases the hammers to intermittently impact the output. The impact mechanism is also fixed axially within the housing. A ratchet head assembly is operatively connected to the output of the impact mechanism. The ratchet head assembly includes an output member rotatably mounted on the housing to rotate the mechanical fastener. The assembly also includes a ratchet operable to limit rotation of the output member in a selected direction.

In another aspect of the invention, the tool comprises a housing with first and second ends and a longitudinal axis extending between the ends. A head is attached to the housing toward the first end for operatively engaging the mechanical fastener. A motor with a motor shaft is disposed in the housing toward the send end for driving the head. An impact drive is disposed in the housing between the motor and the head and operatively connects the motor to the head. The impact drive has an input connected to a cam plate and a pair of pivotable hammers. The hammers are biased by the cam plate toward a striking position. The impact drive also has an output shaft disposed for rotation in response to rotation of the input. The hammers intermittently strike the output shaft for increasing the torque applied to the output shaft to selectively increase the torque transmitted to the head for tightening or loosening the mechanical fastener.

In yet another aspect of the invention, a pneumatic tool for tightening and loosening a mechanical comprises an elongate tubular housing sized for being held in one hand. A pneumatic motor in the housing has a motor shaft adapted to be rotated by the motor. An impact drive in the housing operatively connects to the motor shaft. The impact drive has an output shaft disposed for rotation and a pair of hammers pivotal bay a cam plate for intermittently providing an increased torque on the output shaft. The cam plate and the output shaft are generally coaxial. The impact drive is also fixed axially within the housing. A ratchet head assembly operatively connects to the output shaft of the impact drive. The ratchet head assembly includes an output member rotatably mounted on the hosing and capable of engaging the mechanical fastener. A ratchet mechanism is operable to limit rotation of the output member in one direction.

Other objects and features will be in part apparent and in part pointed out hereinafter.

### BRIEF DESCRIPTION OF THE DRAWINGS

FIG. 1 is a perspective of a hand-held pneumatic ratchet wrench of the invention incorporating an impact drive and pneumatic motor;

FIG. 2 is an elevation of the wrench of FIG. 1 in partial section to show internal construction;

FIG. 3 is a separated perspective of a head of the wrench incorporating a ratchet mechanism;

FIG. 4 is a perspective of an impact drive of the pneumatic ratchet wrench broken away to show internal construction; and

FIG. 5 is a separated perspective of the impact drive of FIG. 4.

Corresponding reference characters indicate corresponding parts throughout the drawings.

### DESCRIPTION OF THE PREFERRED EMBODIMENTS

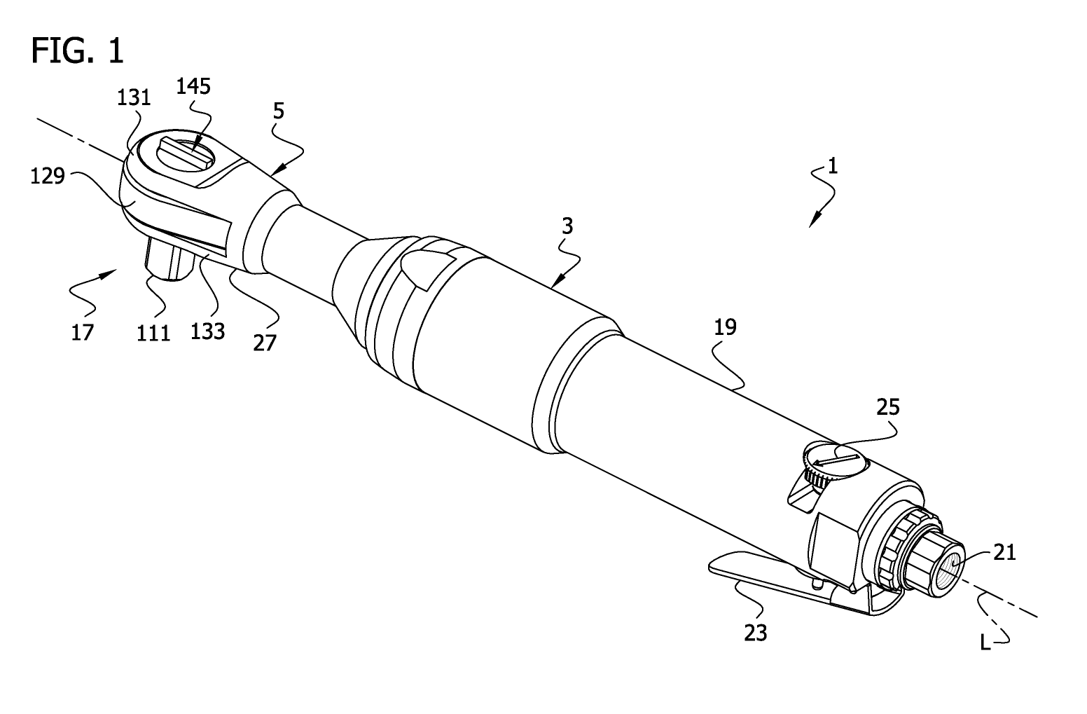

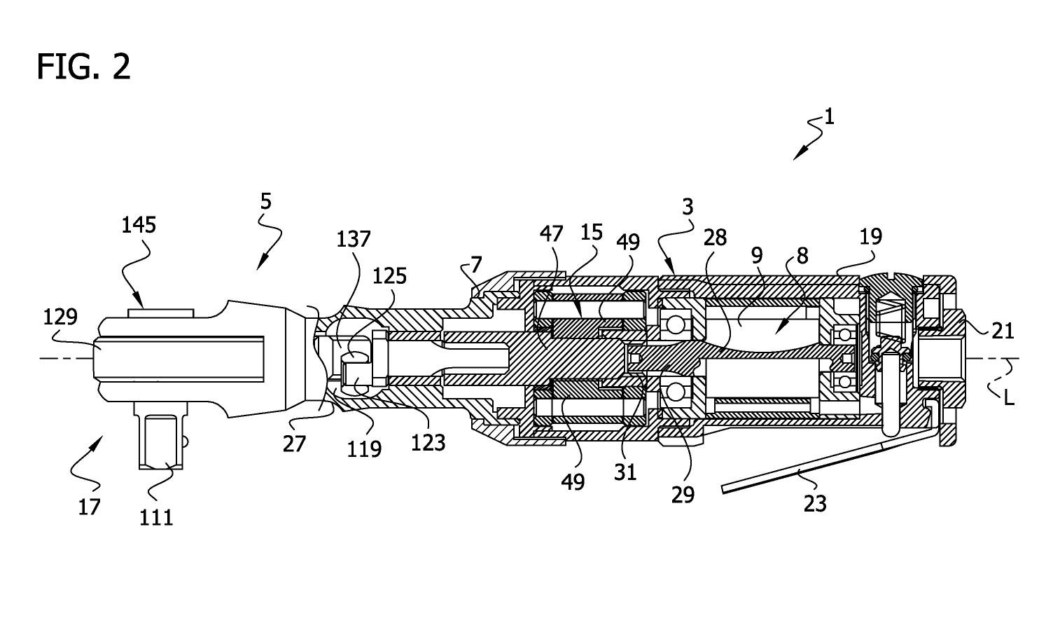

Referring now to the drawings, and particularly to FIGS. 1 and 2, a hand-held power driven ratchet wrench is generally indicated at reference numeral 1. The wrench 1 includes a tubular housing, indicated generally at 3, and a head, indicated generally at 5. As shown in FIG. 2, the housing 3 and head 5 are connected by a threaded internal coupling 7 and securely encase the functional components of the wrench 1, including a motor, generally indicated at 8, having a rotor 9. The housing 3 also contains an impact drive 15 and a ratchet mechanism 17 (the reference numerals designating their subjects generally). Each of these components will be described in greater detail hereinafter. For convenience of description, when describing orientation of these components, the head 5 is understood to be located toward a forward end of the wrench 1 and the motor 8 toward a rearward end. The motor 8 illustrated and described herein is a standard air driven motor of the type commonly used in pneumatic tools. Because the motor 8 is conventional, it will not be described in further detail.

Referring to FIG. 1, the housing 3 generally includes an elongate grip or handle 19 having a rearward end and a forward end. An air inlet fitting 21 is located toward the rearward end of the housing 3 and is capable of connecting the wrench 1 to an external source of pressurized air (not shown). A lever 23 and a control dial 25 provided near the air inlet fitting 21 control the airflow to the motor 8. The lever 23 is pivotally mounted on the housing 3 and is spring biased to a radially outward position with respect to the housing so that it can be squeezed to actuate a valve (not shown) to selectively permit pressurized air to flow through the air inlet fitting 21 to the motor 8.

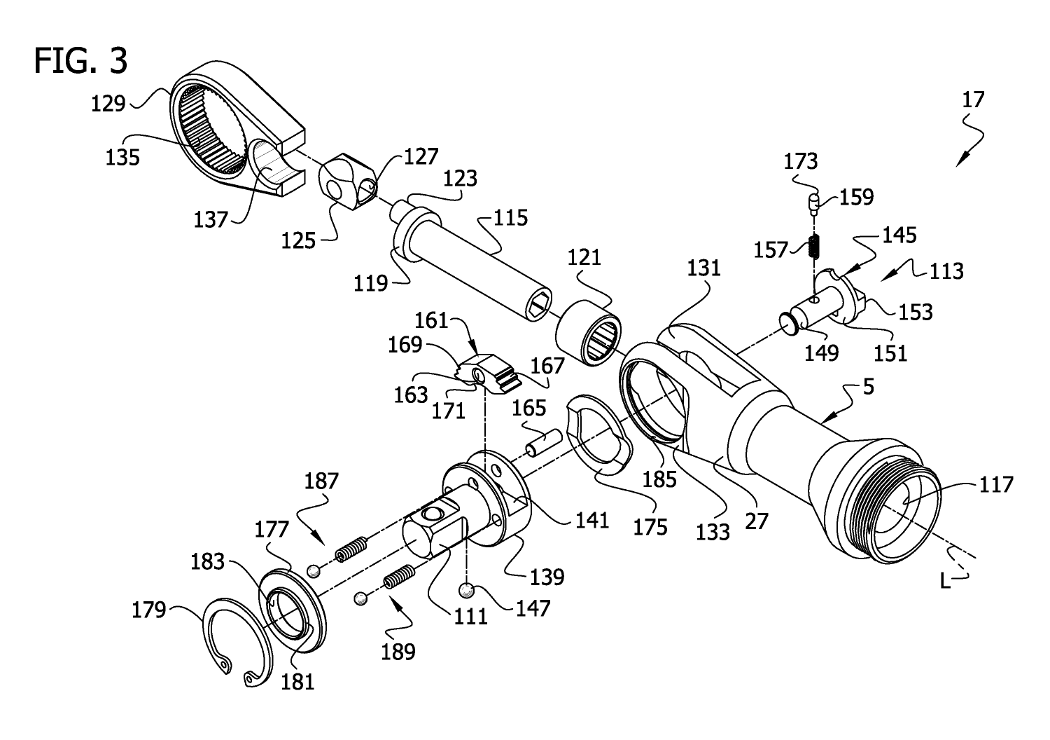

Referring to FIGS. 1-3 together, the ratchet head assembly 17 is located toward a forward end of the wrench 1, generally at the head 5, and is supported within a yoke 27 of the head. The illustrated ratchet head assembly 17 is similar to that shown in U.S. Pat. No. 4,346,630 (Hanson) and generally includes an output member 111 rotatably mounted on the housing 3 for engaging the mechanical fastener, and a ratchet mechanism, generally designated 113, operable to limit rotation of the output member in one direction. Because the ratchet head assembly 17 is conventional, it will not be described in further detail.

An impact output drive 47 is connected to the ratchet mechanism 113 and converts the rotary motion of the output shaft into oscillating motion of the ratchet mechanism. The impact output drive 47 extends into a passage 119 of the head 5. A crank 123 extends from the output drive 47. The crank 123 is off-center with respect to the output drive. A drive bearing 125 having generally spherical sides and an opening 127 rotatably receives the crank 123 (FIG. 2). An oscillating member 129 of the ratchet mechanism 113 is located between arms 131, 133 of the yoke 27 of the head 5. The oscillating member 129 includes a toothed opening 135 that is aligned with openings in the arms 131, 133 of the yoke 27 for receiving components of the ratchet mechanism 113, as will be described hereinafter. The oscillating member 129 also includes a semicircular opening 137 that slidably receives the drive bearing 125 connected to the crank 123. As the crank 123 rotates, the drive bearing 125 moves in a circular motion within the semicircular opening 137 of the oscillating member 129, causing the member 129 to rock back and forth about a longitudinal axis of the output member 111.

The ratchet mechanism 113 includes a rotary member 139 sized to fit in the openings of the yoke arms 131, 133 and oscillatory member 129. The rotary member 139 has a generally circumferential slot 141 extending through about half of its circumference. The output member 111 extends laterally outward from the rotary member 139. Opposite the output member 111 in the rotary member 139 is an axial bore 143 that intersects the bottom of the circumferential slot 141 as shown in FIG. 2. A selector 145 for selecting rotational direction of the ratchet head assembly 17 (e.g., clockwise or counterclockwise) is received in the axial bore 143 (secured by ball bearing 147 in groove 149) and includes a disk 151 having a fingerpiece 153 extending from one side to allow manual rotation. The selector 145 has an extending shaft 155 with a transverse bore receiving a spring 157 for biasing a plunger 159.

The ratchet mechanism 113 also includes a ratchet pawl, designated generally at 161, for controlling rotational direction of the ratchet head assembly 17. The pawl 161 has a transverse opening 163 through it so that it can be mounted in the circumferential slot 141 in the rotary member 139 by inserting a pin 165 through the sides of the pawl and the sides of the rotary member. The pawl 161 has slanted or generally arcuate end parts as designated at 167 and 169. These end parts have teeth that are configured to engage the teeth on the inside of the opening 135 of the oscillatory member 129. The pawl 161 has a groove or channel 171 formed in one longitudinal side that pivots on the pin 165 when pushed by a free end 173 of the plunger, which is held against the pawl by the spring 157. Thus, by manually rotating the selector 145 by using the fingerpiece 153, the selector shaft can be rotated angularly, which rotates the plunger 159 within the channel 171 of the pawl 161. In a first position, the pawl 161 is positioned to be rotated by the oscillating member 129 angularly in one direction (e.g., clockwise). In a second position, the pawl 161 is positioned to be rotated by the oscillating member 129 angularly in the opposite direction (e.g., counterclockwise). Each end of the ratchet pawl 161 operates only in one direction, and is free to move in a direction opposite to that operating direction.

The rotary member 139 is held in the yoke 27 of the head 5 on one side by a thrust washer 175, which is generally resilient and made of a spring material. The thrust washer 175 has waves in a circumferential direction so that it can be compressed between the rotary member 139 and yoke 27, holding them together. On the other side of the head 5, the rotary member 139 is held in place within the yoke 27 by a plate 177 and snap ring 179. The plate 177 has a circular boss 181, holding the snap ring 179 and a center bore 183 fitting over the output member 111. The plate 177 fits into the opening of one arm 133 of the yoke 27 and is held in place by the snap ring 179 positioned in a groove 185 in the yoke arm opening. Spring loaded ball bearings (each designated generally by 187 and 189) apply force to hold the plate 177, thrust washer 175, and rotary member 139 in place. It should be understood that the wrench may have a head with a different mechanism for engaging fasteners, for example a direct drive socket head, without departing from the scope of the invention.

In operation, the output shaft 47 pivots the oscillating member 129 about the longitudinal axis of the output member 111. When oriented for turning a fastener in a clockwise direction, the pawl is pivoted on plunger 159 so the pawl end part 169 engages the opening 135 of the oscillating member 129. The oscillating member 129 first moves clockwise when the crank shaft 115 and drive 125 rotate. The teeth of the opening 135 of the oscillating member 129 engage the teeth of the pawl end part 169 and cause the rotary member 139 to rotate clockwise with the oscillating member. This also rotates the fastener clockwise. After the crank shaft 115 rotates one half rotation (i.e., rotates 180°), the drive 125 causes the oscillating member 129 to reverse rotation and rotate counterclockwise. The teeth of the oscillating member's opening 135 disengage the teeth of the pawl end part 169 and slide past each other. Here, the rotary member 139 does not move. Once the crank shaft 115 rotates another half rotation, the drive 125 again causes the oscillating member 129 to reverse rotation back in a counterclockwise direction. This causes the teeth of the opening 169 in the oscillating member 129 to re-engage the teeth of the pawl end part 169 and rotate the rotary member 139, further turning fastener again. The process repeats until the motor 8 is disengaged. Operation is similar for turning a fastener in a counterclockwise direction, except the pawl end part 167 (instead of end part 169) engages the teeth of the opening 135 so the fastener can be turned in the opposite direction (i.e., counterclockwise).

As previously described, the pneumatic motor 8 is disposed generally in the housing 3 toward its rearward end. As shown in FIGS. 2, 4, and 5, the rotor 9 includes vanes 28 and a motor shaft 29 positioned generally coaxially with a longitudinal axis L of the wrench (FIG. 1) and extending longitudinally forward from the rotor 9 toward the head 5. Splines 31 at a forward end of the motor shaft 29 mesh with splines 33 of the impact drive 15 for driving the impact drive.

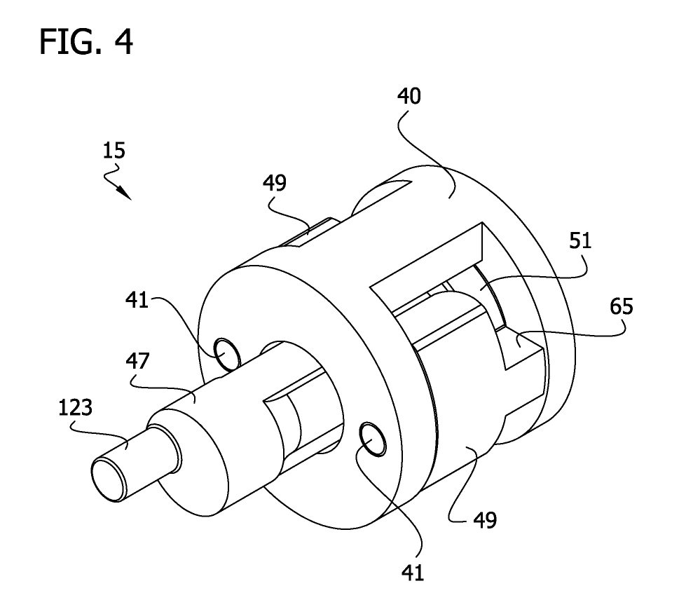

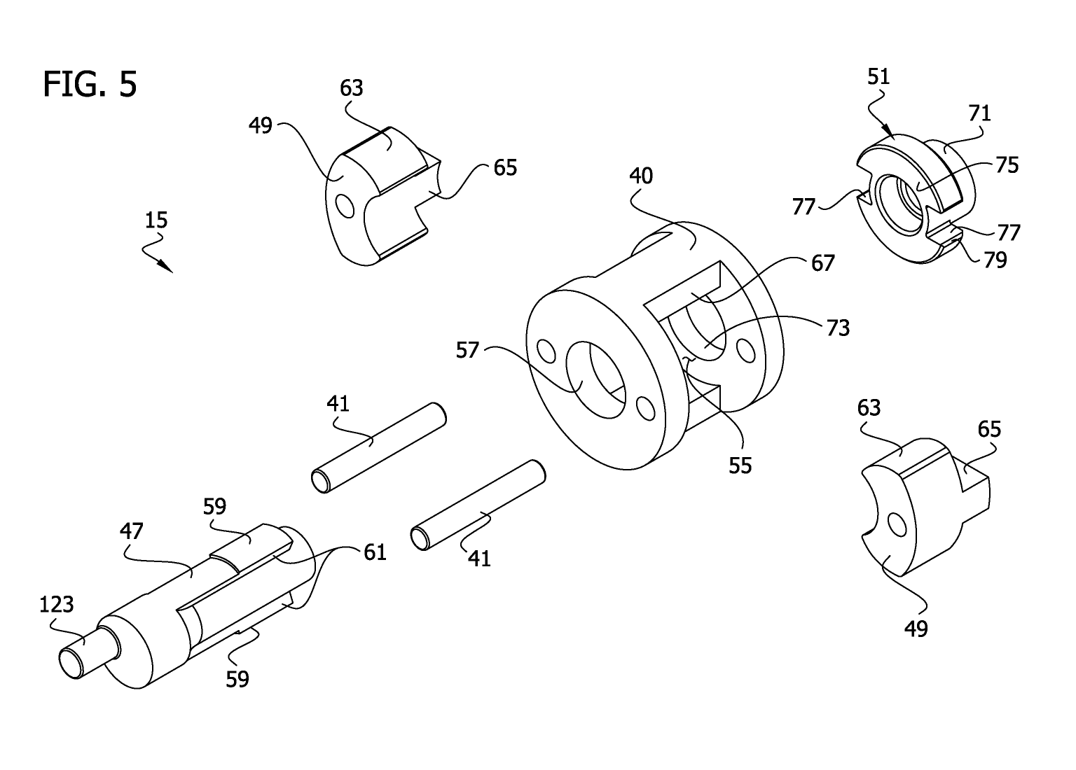

The impact drive 15 of the wrench 1 illustrated and described herein has components supported generally within a clutch case or base 40 (FIGS. 4 and 5) and incorporates the output shaft 47, two substantially identical hammers (each indicated generally at 49) and a cam 51. The hammers 49 are pivotally mounted on pins 41 extending through the case 40. The output shaft 47 is centrally positioned within the clutch case 40, generally coaxially with a longitudinal axis of the housing 3 that aligns with the longitudinal axis L of the wrench (see FIG. 2). The output shaft 47 can rotate independently from the clutch case 40. The output shaft 47 is also generally coaxial with the motor shaft 29. The output shaft 47 sits on the cam 51 (without a spline connection) and extends within a central passage 55 and through an opening 57 in the top plate of the clutch case 40. Two substantially identical rectangular anvils (each shown generally at 59) are formed as one piece with the output shaft 47 and extend along the length of the output shaft, projecting radially outward in opposite directions. Each anvil 59 has two impact surfaces 61 that engage respective striking surface 63 of the hammers 49 when the hammers move to provide additional torque to the output shaft 47. The particular impact surfaces 61 that engages during operation depends upon the direction of rotation of the clutch case 40 (i.e., whether the wrench 1 is tightening or loosening a fastener).

The hammers 49 also include a follower portion 65. The hammers 49 are partially received in two opposing, axially extending side openings 67 formed in the wall of the clutch case 40 (see FIG. 4). It is understood the wrench may have different anvil shapes or hammer shapes without departing from the scope of the invention.

The cam 51 comprises a ring member having a journal 71 sized for receipt in a bushing 73 in a bottom plate of the clutch case 40. An inner surface of the journal 71 has splines 33. The cam 51 also includes a circular plate member 75 having a larger outer diameter than the journal 71 so the plate member rests on the bottom plate of the clutch case 40. The plate member 75 also includes two opposing notches 77. The edges of the notches 77 form cam surfaces 79. The notches 77 are sized and shaped to receive the follower portion 65 of the hammers 49. The top side of the plate member 75 provides a surface on which the output shaft 47 sits. The cam 51 is partially rotatable with respect to the clutch case 40. When the cam 51 rotates with respect to the clutch case 40 the cam surfaces engage the follower portion 65 of the hammers 49 for pivoting the hammers about the pins 41. The pivoting motion of the hammers 49 causes the striking surface 63 to intermittently contact the impact surfaces 61 on the output shaft 47.

In general operation of the wrench 1, air enters through the air inlet fitting 21 to power the pneumatic motor 8 and rotate the motor shaft 29. The motor shaft rotates the clutch case 40. The loose fitting of the output shaft 47 in the clutch case 40 is sufficient for the output shaft to rotate conjointly with the clutch case, allowing for normal tightening or loosening operation.

When operating to tighten a fastener, the output shaft 47 is initially loaded with a small torque caused by frictional resistance of the fastener. The initial resistance is generally insufficient to overcome the loose fit connection between the output shaft 47 and the clutch case 40 causing conjoint rotation of the two. As frictional resistance of the fastener increases, torque in the output shaft 47 also increases. At some point, the frictional resistance of the fastener is sufficient to temporarily stop the output shaft 47 from rotating. When this occurs, the clutch case 40 will continue to rotate around the output shaft 47. The cam 51 will remain initially stationary causing the hammers 49 to pivot into engagement with the output shaft 47. As the clutch case 40 continues to rotate, the hammers 49 will deliver an instantaneous impact to the anvils 59 on the output shaft 47 producing an additional torque on the output shaft to attempt to turn the fastener. As the clutch case 40 continues to turn, the hammers 49 pivot, riding over the rectangular anvils 59 on the output shaft 47 before dropping inward to impact the next passing anvil. The clutch case 40 will continue to rotate under the force from the motor 8. The operating sequence of the wrench 1 is then repeated until the fastener is fully tightened.

It will be understood that operation for loosening a fastener is substantially similar, with the exception that the initial torque in the output shaft 47 may be larger because frictional resistance of the fastener is generally initially greater (because the fastener is already tightened). Therefore, hammers 49 will begin impacting the anvils 59 sooner.

It is envisioned that the wrench of the present invention can operate at relatively high pressures thus producing relatively high rotational speeds with the motor shaft of the motor. It is therefore a benefit of this wrench that the impact drive 15 is capable of handling such high pressures without the need for a speed reducing mechanism and without undergoing excessive wear on the components. The loose fitting connection between the output shaft 47 and the clutch case 40 along with the nature of the impact between the hammers 49 and the anvils 59 function to minimize the wear.

Traditional pin type clutch mechanisms are problematic because the cam ball can push the hammers into repeated registration with the anvils when the output shaft is unable to turn the fastener.

Components of the wrench of this invention are made of a suitable rigid material, such as metal (ex., cold-forged steel). But a wrench having components made of different materials does not depart from the scope of this invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above construction without departing from the scope of the invention, it is intended that all matter contained in the above description and shown in the accompanying drawings shall be interpreted as illustrative and not in a limiting sense.

What is claimed is:

1. A power driven tool for rotating a mechanical element, the tool comprising:
a housing;
a motor positioned in the housing having a drive shaft extending therefrom, said shaft rotating relative to the housing during motor operation;
an impact mechanism axially fixed within the housing and operatively connected to the motor drive shaft, the impact mechanism including a base, an output rotatably mounted on the base, a cam rotatably mounted on the base, and a pair of hammers, each of said hammers being pivotally mounted on the base and selectively positioned by the cam, said cam biasing the hammers to intermittently impact the output; and
a ratchet head assembly operatively connected to the output of the impact mechanism, the ratchet head assembly including an output member mounted for rotation relative to the housing to rotate the mechanical element, and a ratchet operable to limit rotation of the output member in a selected direction.

2. A power driven tool as set forth in claim 1 wherein the ratchet head comprises an oscillating member operatively connected to the output shaft of the impact drive for converting rotary motion of the impact drive output shaft into oscillating motion.

3. A power driven tool as set forth in claim 2 wherein the ratchet head further comprises a pawl driven by the oscillating member for driving rotation of the output member.

4. A power driven tool as set forth in claim 1 wherein each of the hammers is mounted on the base for pivotal movement about a corresponding axis extending parallel to a longitudinal axis of the housing.

5. A power driven tool as set forth in claim 4 wherein the hammers simultaneously impact the output shaft to provide the increased torque on the output shaft.

6. A power driven tool as set forth in claim 5 wherein the output shaft rotates separately from the base in response to the impact from the hammers.

7. A power driven tool as set forth in claim 1 wherein the motor is a pneumatic motor.

8. A power driven tool as set forth in claim 7 wherein the housing includes a handle positioned opposite the ratchet head for grasping to hold the tool in one hand, the handle including an air inlet fitting and a lever for controlling air delivery to the motor.

9. A power driven tool for tightening and loosening a mechanical fastener, the tool comprising:
a housing having first and second ends and a longitudinal axis extending between the first and second ends;
a head attached to the housing toward the first end of the housing for operatively engaging the mechanical fastener;
a motor disposed in the housing toward the second end of the housing for driving the head, the motor having a motor shaft;
an impact drive disposed in the housing between the motor and the head and operatively connecting the motor to the head, the impact drive having an input connected to a cam plate, a pair of pivotable hammers biased by the cam plate toward a striking position and an output shaft disposed for rotation in response to rotation of the input, the hammers intermittently striking the output shaft for increasing the torque applied to the output shaft to selectively increase the torque transmitted to the head for tightening or loosening the mechanical fastener.

10. A power driven tool as set forth in claim 9 wherein the impact drive includes a base, each of the hammers being mounted on the base for pivotal movement about a corresponding axis extending parallel to a longitudinal axis of the housing.

11. A power driven tool as set forth in claim 10 wherein the hammers simultaneously impact the output shaft to provide the increased torque on the output shaft.

12. A power driven tool as set forth in claim 11 wherein the output shaft rotates separately from the base in response to the impact from the hammers.

13. A power driven tool as set forth in claim 9 wherein the motor is a pneumatic motor.

14. A power driven tool as set forth in claim 13 wherein the housing includes a handle positioned opposite the ratchet head for grasping to hold the tool in one hand, the handle including an air inlet fitting and a lever for controlling air delivery to the motor.

15. A pneumatic tool for tightening and loosening a mechanical fastener, the tool comprising:
an elongate tubular housing sized for being held in one hand;
a pneumatic motor in the housing having a motor shaft adapted to be rotated by the motor;
an impact drive in the housing operatively connected to the motor shaft, the impact drive having an output shaft disposed for rotation and a pair of hammers pivotal by a cam plate for intermittently providing an increased torque on the output shaft, the cam plate and the output shaft being generally coaxial, the impact drive being fixed axially within the housing;
ratchet head assembly operatively connected to the output shaft of the impact drive, the ratchet head assembly including an output member rotatably mounted on the housing and capable of engaging the mechanical fastener, and a ratchet mechanism operable to limit rotation of the output member in one direction.

16. A pneumatic tool as set forth in claim 15 wherein the impact drive includes a base, each of the hammers being mounted on the base for pivotal movement about a corresponding axis extending parallel to a longitudinal axis of the housing.

17. A power driven tool as set forth in claim 16 wherein the hammers simultaneously impact the output shaft to provide the increased torque on the output shaft.

18. A power driven tool as set forth in claim 17 wherein the output shaft rotates separately from the base in response to the impact from the hammers.

19. A power driven tool as set forth in claim 18 wherein the hammers include follower portions engaged by the cam plate for pivoting the hammers.

20. A power driven tool as set forth in claim 19 wherein the hammers are arcuate in shape.
